(19) United States
(12) Patent Application Publication
(10) Pub. No.: US 2021/0217017 A1
(43) Pub. Date: Jul. 15, 2021

(54) SYSTEM AND METHODS FOR MONITORING RETAIL TRANSACTIONS

(71) Applicant: Shenzhen Malong Technologies Co., Ltd., Shenzhen (CN)

(72) Inventors: Matthew Robert SCOTT, Shenzhen (CN); Wenjuan WANG, Shenzhen (CN); Wenjie FAN, Shenzhen (CN); Yingwen TANG, Shenzhen (CN); Xiaoji LI, Shenzhen (CN); Yan HOU, Shenzhen (CN)

(21) Appl. No.: 16/842,775

(22) Filed: Apr. 8, 2020

Related U.S. Application Data
(63) Continuation of application No. PCT/CN2020/071615, filed on Jan. 12, 2020.

(51) Int. Cl. G06Q 20/40; G06Q 20/20; G06K 9/00; H04N 7/18; G08B 13/24

(52) U.S. Cl. CPC G06Q 20/4016; G06Q 20/208; G06K 9/00771; G06K 2009/00738; H04N 7/181; G08B 13/246; G06K 9/00718

(57) ABSTRACT

Aspects of this disclosure include technologies for monitoring retail transactions, including regular and irregular transactions associated with a check-out machine. The disclosed technical solution utilizes various GUI elements, their configurations, and their interactions with a user to present retail transactions and their information thereof.

### CROSS-REFERENCE TO RELATED APPLICATIONS

This application is a continuation of and claims priority from International Application No. PCT/CN2020/071615, filed on Jan. 12, 2020, entitled “System and Methods for Monitoring Retail Transactions,” which claims priority to, and incorporates by reference herein in its entirety, pending International Application No. PCT/CN2019/111643, filed Oct. 17, 2019, pending International Application No. PCT/CN2019/086367, filed May 10, 2019, and pending International Application No. PCT/CN2019/073390, filed on Jan. 28, 2019.

### BACKGROUND

Barcode and radio-frequency identification (RFID) are two popular technologies used in the retail industry for reading and collecting data in general, and are being commonly applied at the point of sale (POS) or otherwise used for asset tracking and inventory tracking in business. Barcodes were initially developed in linear or one-dimensional (1D) forms. Later, two-dimensional (2D) variants emerged, such as quick response code (QR code), for fast readability and greater storage capacity. Barcodes are scanned traditionally by special optical scanners called barcode readers, which generally requires line of sight visibility. RFID, however, uses radio waves to transmit information from RFID tags to an RFID reader. Typically, RFID tags contain unique identifiers; thus an RFID reader can simultaneously scan multiple RFID tags without line of sight visibility.

Retail shrinkage or shrinkage means there are fewer items in stock than the inventory list, e.g., due to bookkeeping errors or products being stolen. Shrinkage reduces profits for retailers, which may lead to increased prices for consumers to make up for the lost profit. Irregular scans of barcodes or RFID tags, such as missed scans or ticket switching, have caused significant retail shrinkage and other problems (e.g., erroneous inventory information) for retailers, which may further implicate the supply chain and business. Retail systems may not work correctly with irregular scans, whether intentional or unintentional.

### SUMMARY

This Summary is provided to introduce selected concepts that are further described below in the Detailed Description. This Summary is not intended to identify key features or essential features of the claimed subject matter, nor is it intended to be used as an aid in determining the scope of the claimed subject matter.

A scalable technical solution is required to monitor retail transactions effectively efficiently. This disclosure includes technical solutions for monitoring retail transactions associated with both regular and irregular events captured by a camera. One of the objectives of the disclosed system is to enable a user to selectively review important events in a video, so that the deficiencies of conventional systems, such as causing the user to miss important events, could be overcome. Another objective is to quickly prompt the user to the most critical moment (e.g., via a representative frame) in an event quickly, so that deficiencies of conventional systems, such as causing the user to make wrong decisions, could be overcome.

To achieve these objectives, in some embodiments, the disclosed system uses various machine learning models to detect both regular and irregular events from a video captured by a camera. Next, the disclosed system embeds these events in a graphical user interface (GUI) element to illustrate the timeline of these events, and provides visual queues via various GUI elements so that a user can effectively identify various event types and the whereabouts of these events regarding the timeline. Further, with just a single user interaction with the GUI, the disclosed system is configured to enable the user to review a selected event or a critical moment in the event, so that the user can effectively and efficiently monitor retail transactions with the disclosed technologies. Specifically, by providing paired event-control GUI features in some embodiments, a user may directly go to a chosen event by a single user interaction with the GUI. Accordingly, the computer's ability to display information and interact with the user is improved.

In various aspects, systems, methods, and computer-readable storage devices are provided to improve a retail system's functions in monitoring retail transactions. One aspect of the disclosed technology comprises improved GUI features that are configured to enable users to effectively and efficiently monitor retail transactions. Another aspect of the disclosed technology is to improve a computing device's functions to detect regular or irregular events in a video. Yet another aspect of the disclosed technology is to improve a computing device's functions to detect a frame from the video that represents a critical moment of an event. Accordingly, the disclosed technical solution has achieved a technological improvement that allowed computers, for the first time, to provide rapid access to any one of the detected events in a video, and synchronized product information along with the selected event, as well as easy navigation based on the timeline.

### BRIEF DESCRIPTION OF THE DRAWING

The technology described herein is illustrated by way of example and not limited in the accompanying figures in which like reference numerals indicate similar elements and in which:

FIG. 1 is a schematic representation illustrating conventional systems and their problems;

FIG. 2 is a schematic representation illustrating an exemplary system for monitoring retail transactions connected to an exemplary retail environment, in accordance with at least one aspect of the technology described herein;

FIG. 3 is a schematic representation illustrating a part of an exemplary user interface design, in accordance with at least one aspect of the technology described herein;

FIG. 4 is a schematic representation illustrating a part of an exemplary user interface design, in accordance with at least one aspect of the technology described herein;

FIG. 5 is a schematic representation illustrating a part of an exemplary user interface design, in accordance with at least one aspect of the technology described herein;

FIG. 6 is a schematic representation illustrating a process of selecting a frame from a video, in accordance with at least one aspect of the technology described herein;

FIG. 7 is a schematic representation illustrating a process of selecting a frame from a video, in accordance with at least one aspect of the technology described herein;

FIG. 8 is a flow diagram illustrating an exemplary process of monitoring retail transactions, in accordance with at least one aspect of the technology described herein; and

FIG. 9 is a block diagram of an exemplary computing environment suitable for use in implementing various aspects of the technology described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Further, the term “based on” generally denotes that the precedent matter and succedent matter form a technical relationship, or the succedent condition is used in performing the precedent action.

A barcode, a seemingly trivial piece of label, can encode optical, machine-readable data. The universal product code (UPC) is a barcode symbology and is commonly used at the POS for sales. Barcodes, particularly UPC barcodes, have shaped the modern economy. Barcodes or other product identifiers (e.g., RFID), ubiquitously affixed to most commercial products in the modern economy, have made checkout and inventory tracking more efficient in all retail sectors. Not only have they been used universally in retail checkout systems, they have been used for many other automatic identification and data collection tasks.

A regular scan, also referred as a regular event hereinafter, refers to a transaction when the product identifier scanned by a check-out machine matches the actual product in the transaction. An irregular scan, also referred as an irregular event hereinafter, refers to the failure of the check-out machine to collect the accurate product information of the product, including missed scans, duplicated scans, erroneous scans, ticket switch, etc. By way of example, the scanner may miss the barcode due to various reasons, such as obstructions of the line of sight, insufficient time for scanning, or even fraud. Missed scans may be caused unintentionally or intentionally. Duplicated scans may be caused by moving the product back and forth before the scanner. Erroneous scans may be caused by damaged barcodes or even fraudulent behaviors, such as covering or replacing the genuine barcode with a different barcode, typically for another cheaper product.

The integrity of the scanning process, i.e., the process of reading the information encoded in the barcodes or other product identifiers, is critical to normal business. Irregular scans could cause significant shrinkage and other problems for retailers. Conversely, consumers could also be harmed by incorrect transactions caused by irregular scans.

The pending International Application No. PCT/CN2019/111643, filed Oct. 17, 2019, pending International Application No. PCT/CN2019/086367, filed May 10, 2019, and pending International Application No. PCT/CN2019/073390, filed on Jan. 28, 2019, (hereinafter “previous disclosures”) have disclosed effective technical solutions to recognize, correct, or prevent irregular scans, especially with increasingly popular self-checkout retail systems.

Detected irregular events need to be monitored. In other words, human intervention is required to verify or analyze detected irregular events. For example, to resolve an issue related to an irregular scan in real time, a store staff may be required to review the image or the video associate with the irregular event. As another example, to improve the system's precision to detect irregular scans, detected irregular events need to be analyzed, especially for false positives. As another example, detected irregular events need to be analyzed to accurately determine the inventory of a store. As another example, the management team of a store may need to review irregular events to understand the activities in the store as a matter of course.

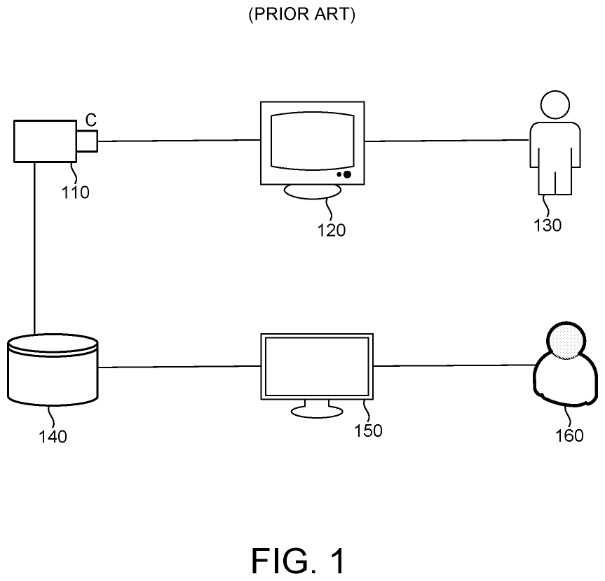

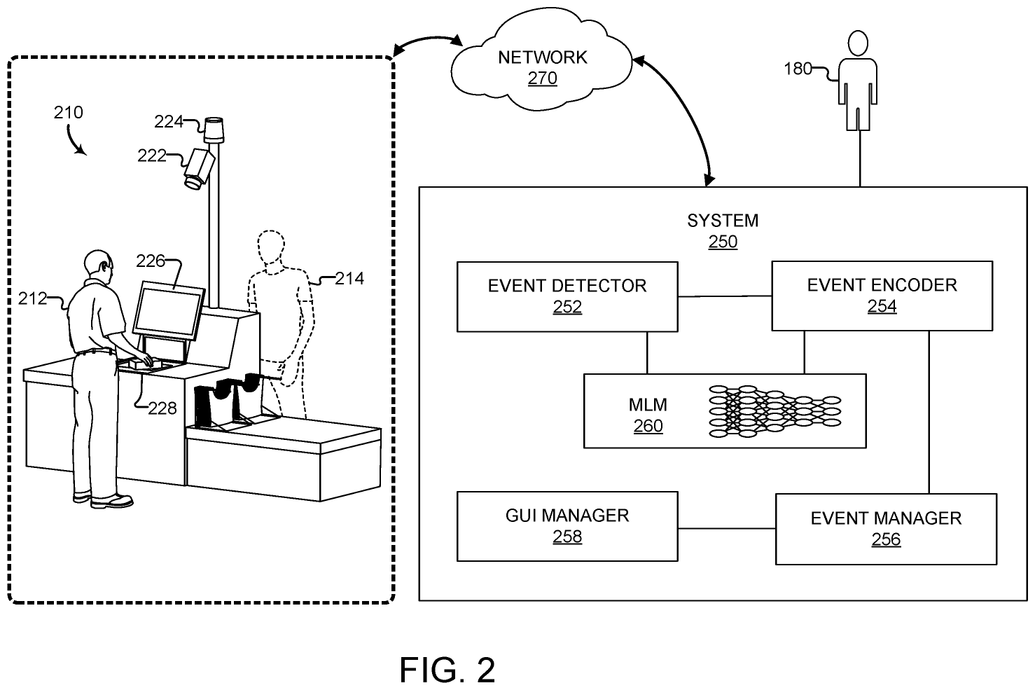

As will be further discussed in connection with FIG. 1, conventional systems are not only incapable of detecting irregular events, but also presents various challenges for users to review the video captured by security camera. In this disclosure, a technical solution is provided to enable effective and efficient review of both regular and irregular events, e.g., captured in a video, which will be further discussed in connection with FIGS. 2-9.

To retailers, the disclosed technical solutions can help them review both regular and irregular events effectively and efficiently, also referred as effective review and efficient review respectively. Comparing to conventional systems, effective review, as used herein, refers to a higher recall rate or a higher precision rate of monitoring all irregular events in a video. Efficient review, as used herein, refers to a function of selectively monitoring a particular irregular event and another function of determining and presenting a critical moment of a particular irregular event.

Further, the disclosed technical solutions can be used to monitor transactions at both clerk-assisted checkout machines and self-checkout machines. As a result, the disclosed technical solutions can help retailers mitigate shrinkage, maintain the integrity of their inventories, or just manage their regular business activities.

Having briefly described an overview of this disclosure, some conventional systems and their associated problems are discussed in connection with FIG. 1. Traditionally, staff 130 may monitor retail transactions when physically presented near a check-out machine, or by watching via closed-circuit television (CCTV) 120, which captures the real-time activities via surveillance camera 110 installed over a check-out machine. This solution may be reserved for monitoring high-value transactions, such as for a jeweler to monitor diamond sales. Obviously, it is unrealistic or at least unaffordable for many retailers to hire workers to monitor each check-out machine. Further, a person usually cannot focus uninterrupted for a long time due to limited perceptual span and attention span.

Another traditional solution is also illustrated in FIG. 1. The video footage from camera 110 may be saved in data storage 140. In this way, user 160 may review the video in near real time or afterwards. By way of example, user 160 may replay the video file with a video player so that the user 160 may detect irregular events by watching the video. However, this solution is like finding a needle in a hay stake because irregular events are relatively rare, and are typically embedded in irregular events. Resultantly, this solution is not only very time-consuming but is also error-prone because a person usually cannot focus uninterrupted for a long time due to limited perceptual span and attention span. Accordingly, a technical solution is needed to enable a user to monitor retail transactions effectively and efficiently.

Referring now to FIG. 2, it illustrates an exemplary system 250 for monitoring retail transactions connected to an exemplary retail environment. This retail environment is merely one example of a suitable computing environment for system 250, and is not intended to suggest any limitation as to the scope of use or functionality of aspects of the technology described herein. Neither should this operating environment be interpreted as having any dependency or requirement relating to any one component nor any combination of components illustrated.

In this operating environment, checkout system 210 includes scanner 228, display 226, camera 222, and light 224. This checkout system may be used by clerk 212 to help customer 214 check out goods. Similarly, this checkout system may also be used by customer 214 for self-checkout.

Enabled by various technologies disclosed in aforementioned previous disclosures, checkout system 210 can detect both regular and irregular scans. Alternatively, event detector 252 is configured to detect both regular and irregular scans from the video footage captured by camera 222 with similar technologies. In either case, the video footage captured by camera 222 may be transmitted to system 250 via network 270, which may include, without limitation, a local area network (LAN) or a wide area network (WAN). Similarly, the identifier (e.g., barcode, RFID, etc.) of the product scanned by scanner 228, may also be passed along with the video to system 250.

At a high level, system 250 is configured to detect both regular and irregular events via event detector 252, and encode them into a timeline via event encoder 254. Subsequently, system 250 may present, via GUI manager 258, the timeline to a display with GUI. In response to a computing event, such as an action originated asynchronously from the external environment, e.g., a user interaction with the GUI, event manager 256 is configured to present a selected event, regular or irregular, to the user. In some embodiments, event manager 256 is configured to play a segment of the video corresponding to the selected event. In some embodiments, event manager 256 is configured to present a particular frame from the segment of video. The particular frame may be determined, e.g., via machine learning model (MLM) 260, to be representative of a critical moment of the event, such as when a product is being scanned, or when the product is most comparable to an exemplary image of the product. In some embodiments, a representative frame is selected if the product in the frame is in a spatial configuration that is easy to recognize and compare, such as in a similar spatial configuration to the product in the exemplary image. The exemplary image may be stored in a local or remote data storage. In various embodiments, one or more exemplary images may be retrieved based on the product identifier, such as the barcode or RFID of the product.

In various embodiments, in addition to detecting various types of events, event detector 252 is also configured to detect various information associated with an event, such as the start time and the finish time of a displacement of the product in the video, the distance of the displacement, the start time and the finish time of when the product passing through the scanning area, the time when scanner 228 reads the product identifier, etc.

In various embodiments, event encoder 254 is to encode an event to the timeline based on its even type and its timestamps. In some embodiments, event encoder 254 is to encode different types of events with different colors or different form factors in the timeline, which will be further discussed in connection with the remaining FIGS. In some embodiments, event encoder 254 is to encode a same type of events with a same color. In some embodiments, event encoder 254 is to encode a same type of events with different form factors, such as based on the start time and finish time of the event, e.g., for a missed scan event.

To detect regular or irregular scans, event detector 252 may utilize MLM 260 to compare the tracked product in the video with the scanned product as represented by its identifier (e.g., a UPC barcode) collected by the scanner. Similarly, to identify a representative frame from a video to represent the event, the image of the tracked product in the video may be compared with the exemplary image associated with the scanned or recognized product.

In one embodiment, the frame with the largest 2D projection area of the product is selected. The 2D projection area of the product refers to the area covered by the actual product on the image in the pixel space.

In another embodiment, the latent features of a product at a frame is compared to the latent features of the exemplary image, e.g., via MLM 260, in a latent space. The frame with the highest similar measure may be selected. In various embodiments, MLM 260 includes various specially designed and trained neural networks to detect objects, track objects, and compare objects, e.g., in a latent space.

As used herein, a neural network comprises at least three operational layers. The three layers can include an input layer, a hidden layer, and an output layer. Each layer comprises neurons. The input layer neurons pass data to neurons in the hidden layer. Neurons in the hidden layer pass data to neurons in the output layer. The output layer then produces a classification. Different types of layers and networks connect neurons in different ways.

Every neuron has weights, an activation function that defines the output of the neuron given an input (including the weights), and an output. The weights are the adjustable parameters that cause a network to produce a correct output. The weights are adjusted during training. Once trained, the weight associated with a given neuron can remain fixed. The other data passing between neurons can change in response to a given input (e.g., image).

The neural network may include many more than three layers. Neural networks with more than one hidden layer may be called deep neural networks. Example neural networks that may be used with aspects of the technology described herein include, but are not limited to, multilayer perceptron (MLP) networks, convolutional neural networks (CNN), recursive neural networks, recurrent neural networks, and long short-term memory (LSTM) (which is a type of recursive neural network). Some embodiments described herein use a convolutional neural network, but aspects of the technology are applicable to other types of multi-layer machine classification technology.

Although examples are described herein with respect to using neural networks, and specifically convolutional neural networks in some embodiments, this is not intended to be limiting. For example, and without limitation, MLM 260 may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoders, convolutional, recurrent, perceptrons, long/short term memory/LSTM, Hopfield, Boltzmann, deep belief, deconvolutional, generative adversarial, liquid state machine, etc.), and/or other types of machine learning models.

Regarding the arrangement of the components in system 250, it should be understood that this and other arrangements described herein are set forth only as examples. Other arrangements and elements (e.g., machines, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

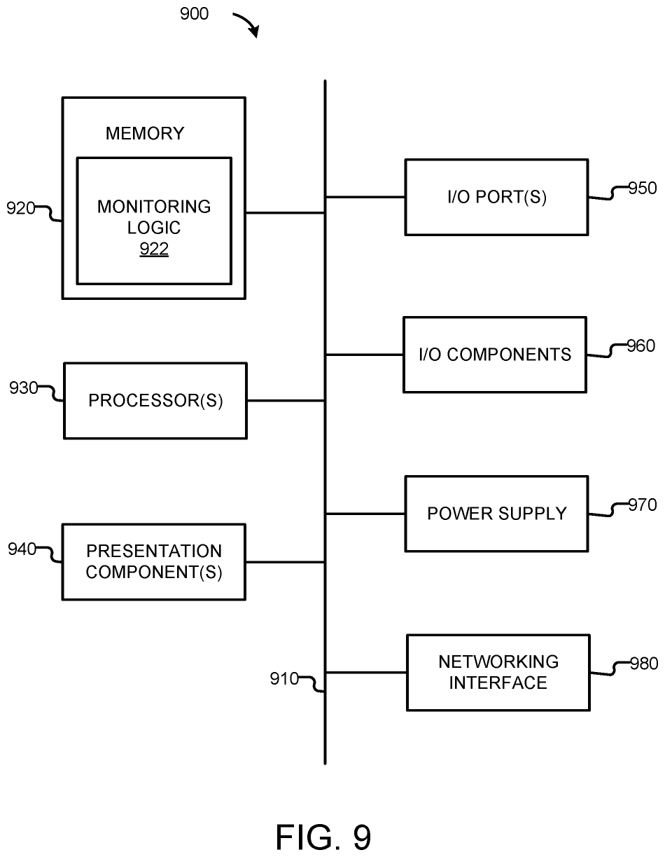

Further, it should be understood that system 250 is an example. Each of the components shown in FIG. 2 may be implemented on any type of computing devices, such as computing device 900 described in FIG. 9, for example. Further, various system components in system 250 may communicate with each other or other devices, such as camera 222, scanner 228, etc., via network 270, which may include, without limitation, a local area network (LAN) or a wide area network (WAN). In exemplary implementations, WANs include the Internet or a cellular network, amongst any of a variety of possible public or private networks. Further, various components in FIG. 2 may be placed in a remote computing cloud or locally within a checkout machine, e.g., checkout system 210.

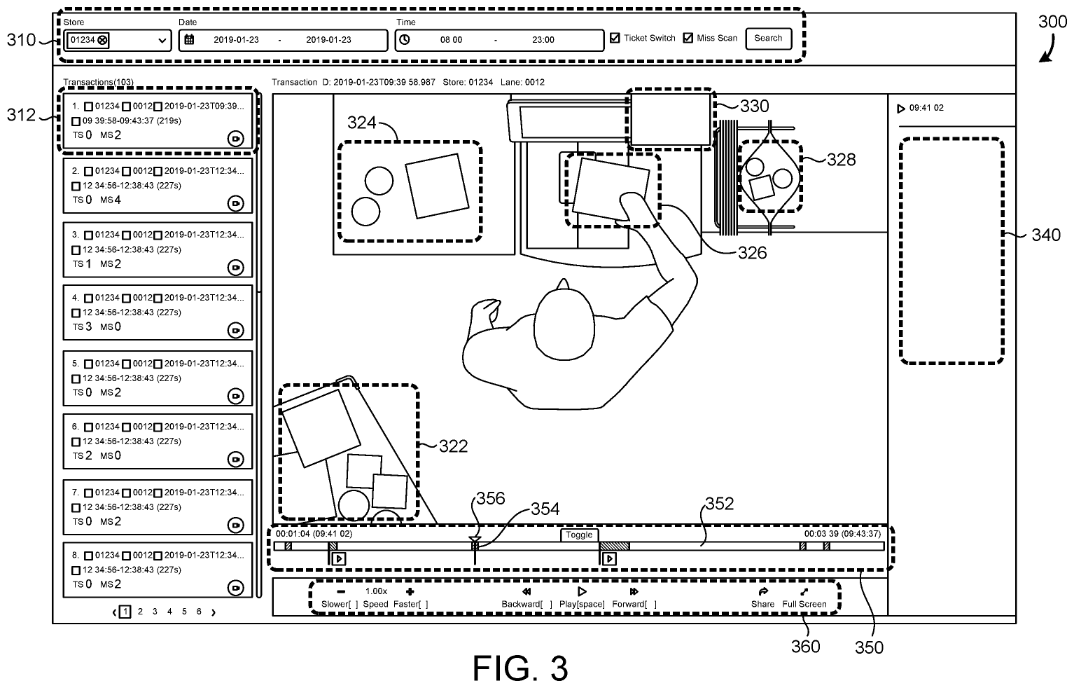

FIG. 3 is a schematic representation illustrating a part of an exemplary user interface design, in accordance with at least one aspect of the technology described herein. GUI 300 illustrates an embodiment enabled by the disclosed technologies. Area 310 includes various GUI elements, which may be used by a user to define various criteria to search regular or irregular events, e.g., based on a store, a date range, a time period, an event type, etc.

Next, in response to a particular video meeting the search criteria, such as video 312, being selected, the disclosed system is to load video 312, and the user may configure various playback parameters through the control elements in area 360. Meanwhile, the disclosed system also loads timeline 352 of the events in the video to area 350.

Various events are encoded to match various segments in timeline 352. In various embodiments, events of different types are encoded differently, such as with different colors or different form factors. In this example, regular scan events are coded in green, which intuitively indicates to the user as regular events. Ticket switch events are coded in yellow, which reminds the user of a likely shrinkage event. Miss scan events are coded in red, which warns the user of a severe shrinkage event.

The user may move progress indicator 356 to event 354. In response to this user interaction, the disclosed system may playback the corresponding video segment. In the frame as shown, area 322 has a shopping cart with various products. Area 324 is a loading area for the customer to load products from the shopping cart. Area 326 is a scanning area of the scanner. Area 330 is the payment area. In some embodiments, area 330 is blacked out with a mask to prevent the payment information, such as a pin to a debit card, from being recorded in the video. Area 328 is a packaging area, where the customer can pack products after scanning.

Area 340 is used to display product information, such as an exemplary image of the product, based on how the disclosed the system recognizes the scanned product. In some embodiments, the disclosed system is to recognize the scanned product based on its identifier, such as its barcode. In this case, the disclosed system can retrieve an exemplary image and related product information based on the product identifier. In some embodiments, the disclosed system is to recognize the scanned product based on one or more images collected from the actual product in the video. In this case, the disclosed system may dynamically update the product information in areas 340 as the system may update its knowledge of the product after collecting more images.

Advantageously, GUI 300 is configured to enable a user to get an overview of all events in a timeline, and quickly understand the event types based on their colors or form factors. Further, GUI 300 is configured to enable the user to selectively review any one of the events in the timeline. In this way, the user would not miss an event, especially an irregular event, such as ticket switch events or miss scan events in this case.

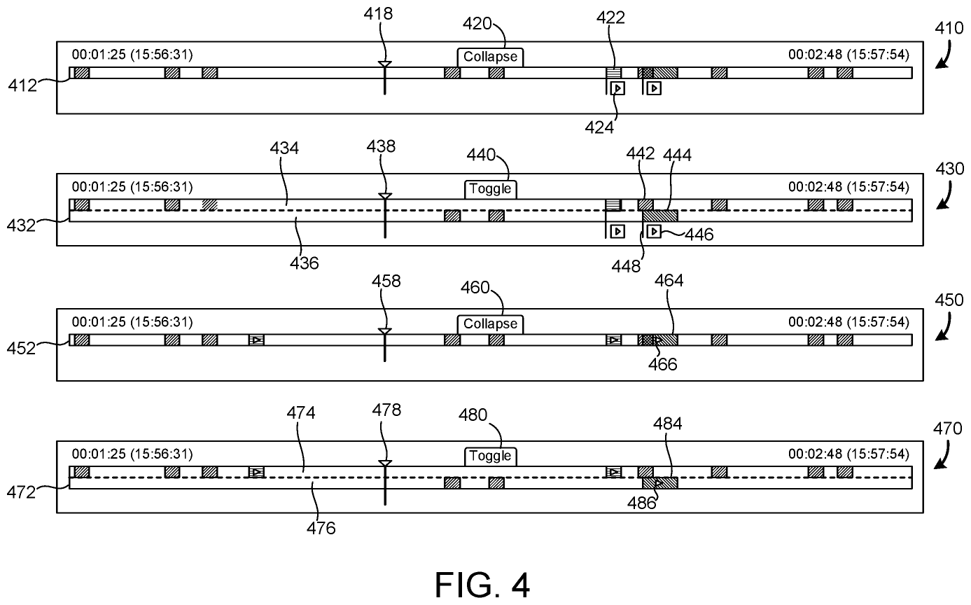

FIG. 4 is a schematic representation illustrating a part of an exemplary user interface design, in accordance with at least one aspect of the technology described herein. The GUI elements for the timeline may be collapsed in some embodiments. This collapse function causes the GUI element for the timeline to split into two areas so that different types of events may be separated into different areas. This is especially useful when different events overlap to each other. By way of example, an regular event may overlap with or be immediately followed by an irregular event. After the separation, the user can easily perceive the type of events and their respective start and finish times.

In block 410, element 412 represents the timeline. Element 418 represents a progress indicator. The location of element 408 in respect to the timeline represents the timestamp of the frame of the video currently displayed in the GUI. Element 420 is a control to collapse the timeline. As shown, element 422 represents an irregular event, such as a ticket switch event. Element 424 is paired with element 422, and element 424 is configured to be displayed directly beneath element 422. In this embodiment element 424 is configured as a small play button. In other embodiments, element 424 may take a different shape or form factor.

In response to a user interaction with element 420, such as a mouse click event received from a mouse or a touch event received from a touchscreen, the part of the GUI in block 410 may change to the part of the GUI in block 430.

In block 430, element 432 represents the timeline. However, element 432 has separated into area 434 and area 436. Element 438 remains at the same location. Element 440 now changed its indication from collapse to toggle. Most notably, element 442 and element 444 now relocate to respective areas in the timeline. This part of the GUI is configured to clearly indicate to the user that element 442 represents a regular event according to its shape and color, and element 444 represents an irregular event based on its color and shape. Additionally, element 448 relates elements of 444 with element 446. Accordingly, the user can easily understand that if an interaction is applied to elements 446, the video segment associated with element 444 will be presented.

In block 450, element 452 represents the timeline. Element 458 represents a progress indicator. Elements 460 is similar to element 420. It should be noted that element 464 and element 466 are now in the overlapping configuration. In one embodiment, their respective centers are at the same position. Advantageously, a user can intuitively understand that element 466 is related to element 464. However, in this instance, another regular event also overlaps with element 464, which may cause confusion.

In response to a user interaction with elements 460, the part of the GUI in block 450 may change to the part of GUI in block 470. Noticeably, elements 407 is now split to two areas, namely area 474 and area 476. Element 478 remains at the same location as element 458. Element 480 changes its indication. Noticeably, the overlapping regular events stayed in area 474, and element 484 and element 486 moved to area 476. Advantageously, this figure clearly shows that element 486 is a control elements in connection with element 484.

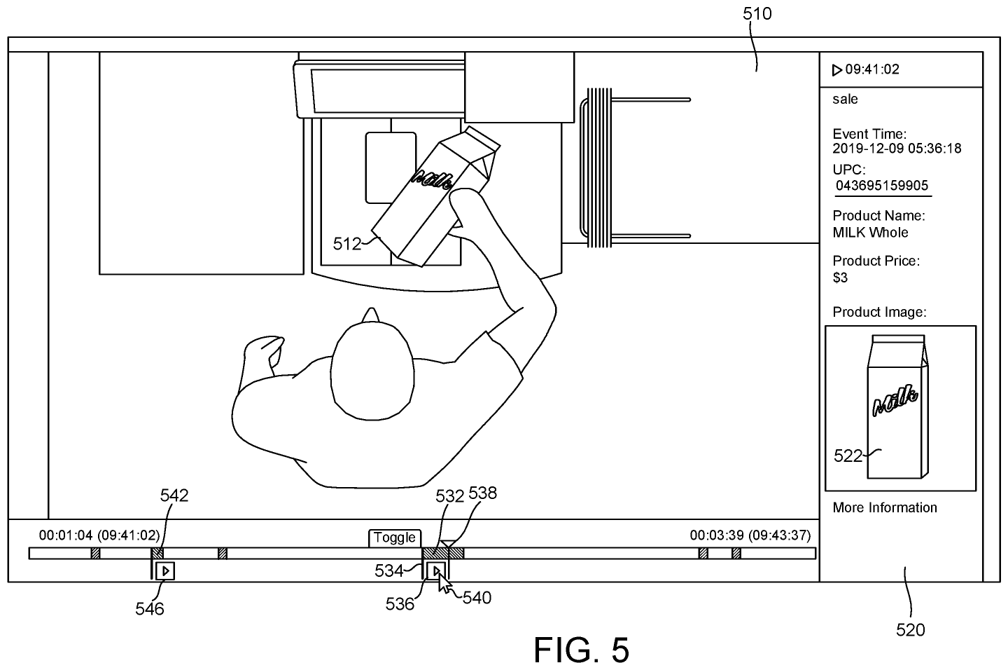

FIG. 5 is a schematic representation illustrating a part of an exemplary user interface design, in accordance with at least one aspect of the technology described herein. FIG. 5 illustrates several different embodiments of how the system responds to a user interaction with element 536, particularly to synchronize the product information in window 520 with the event displayed in window 510, in order to facilitate the user to verify the event.

Here, element 532 is mapped to a video segment corresponding to an irregular event encoded to element 532. In some embodiments, a video segment corresponding to an irregular event is alternatively mapped to element 536 directly, as element 536 and element 532 forms a one-to-one relationship or paired together. Further, element 534 indicates to users a connection between element 532 and element 536. Similarly, element 542 and element 546 forms another pair. Advantageously, a user can directly go to selected event by using a single user interaction, such as selectively clicking on element 536 or element 546. This GUI feature greatly enabled the user to effectively and efficiently monitor retail transactions.

Element 536 may trigger various system reactions. In some embodiments, when the user hovers element 540 over element 536, the system may present a representative frame from the video segment responding to element 532. In some embodiments, when the user clicks or touches element 536, the system may present a representative frame from the video segment. In some embodiments, when the user clicks or touches element 536, the system may start to play the video segment, starting from the beginning of element 532. When a representative frame is shown in window 510, element 538 will move to a specific location based on the timestamp of the representative frame.

Meanwhile, in response to the user interaction with element 536, the system may display various product information in window 520. In some embodiments, an exemplary image 522 of the presumed product will be displayed in window 520. As discussed previously, exemplary image 522 may be retrieved based on the product identifier captured by the scanner. In other embodiments, the disclosed system will alternatively or additionally recognize product 512 in window 510 based on the aforementioned computer vision technologies, e.g., via MLM 260 in FIG. 2.

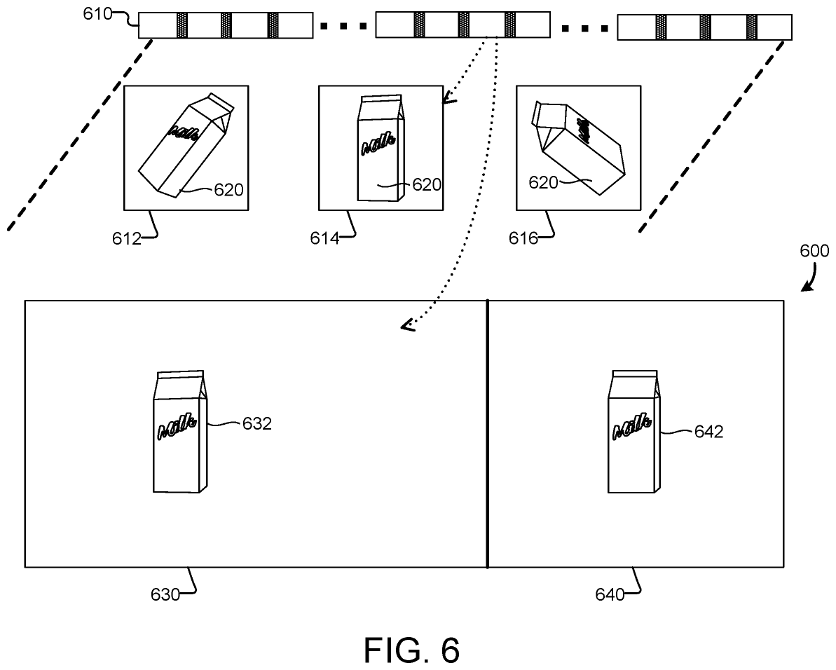

FIG. 6 is a schematic representation illustrating a process of selecting a frame from a video, in accordance with at least one aspect of the technology described herein. Video 610 includes many frames. Each frame is an image. Video 610 may capture the movement of product 620 over a period of time, e.g., over the scanning area or from the loading area to the packaging area.

As product 620 moves, the spatial configuration of product 620 in the video may continue to change. Although product 620 is a 3D object, a video frame will only show its 2D projection on a plane determined based on the spatial configuration of the camera. As a result, product 620 may be displayed as different images in frame 612, frame 614, and frame 616, which are some random frames in video 610. Clearly, among the three random frames, frame 614 is more suitable to be displayed in window 630 in view of the exemplary image 642.

Exemplary image 642 of the scanned product may be retrieved, e.g., based on the scanned barcode. Exemplary image 642 is displayed in window 640. The system may then select a representative frame from video 610 to display in window 630. By juxtaposing the representative frame, showing the actual product 632, and exemplary image 642 642, the user can compare the actual product on the left with Exemplary image 642 on the right easily. Advantageously, with this configuration of GUI 600, a user can more easily verify whether the system detected a regular or irregular event correctly.

In some embodiments, the representative frame may be selected based on the area of product 620 in the frame as a typical exemplary product image is usually shot to show the maximum view of the product. Here, the area of product 620 in a frame may be determined based on the pixels occupied by product 620, also referred as the product pixels. The frame with the maximum product pixels may be selected as the representative frame.

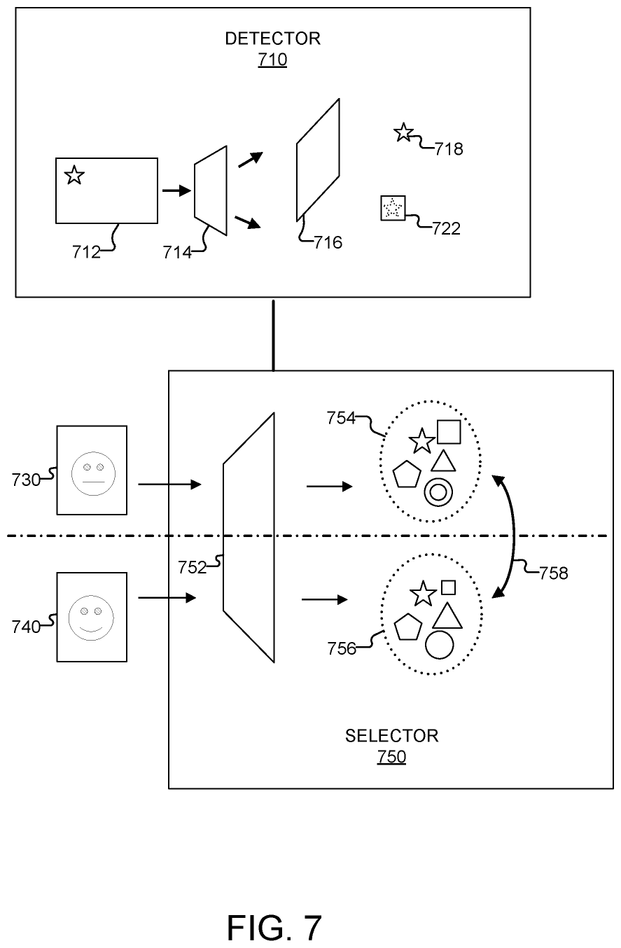

In some embodiments, the visual features of the actual product may be compared to the visual features of the exemplary image, which will be further discussed in connection with FIG. 7. In this case, the frame with the maximum similarity measure may be selected as the representative frame.

FIG. 7 is a schematic representation illustrating a process of selecting a frame from a video, in accordance with at least one aspect of the technology described herein. Detector 710 is configured to detect a product and extract the product image from a frame, e.g., via neural network 714. Selector 750 is configured to select a frame from a video by comparing the actual product image to the exemplary product image, e.g., via neural network 752.

Neural network 714 or neural network 752 includes one or more convolutional neural networks (CNNs). A CNN may include any number of layers. The objective of one type of layers (e.g., Convolutional, Relu, and Pool) is to extract features of the input image, while the objective of another type of layers (e.g., FC and Softmax) is to classify based on the extracted features.

An input layer of a CNN may hold values associated with the input image, such as values representing the raw pixel values of the image as a volume (e.g., a width, W, a height, H, and color channels, C (e.g., RGB), such as W×H×C. One or more layers in the CNN may include convolutional layers. The convolutional layers may compute the output of neurons that are connected to local regions in an input layer (e.g., the input layer), each neuron computing a dot product between their weights and a small region they are connected to in the input volume. In a convolutional process, a filter, a kernel, or a feature detector includes a small matrix used for features detection. Convolved features, activation maps, or feature maps are the output volume formed by sliding the filter over the image and computing the dot product. An exemplary result of a convolutional layer may be another volume, with one of the dimensions based on the number of filters applied (e.g., width, height, and the number of filters, F, such as W×H×F, if F were the number of filters).

One or more of the layers may include a rectified linear unit (ReLU) layer. The ReLU layer(s) may apply an elementwise activation function, such as the max (0, x), thresholding at zero, for example, which turns negative values to zeros (thresholding at zero). The resulting volume of a ReLU layer may be the same as the volume of the input of the ReLU layer. This layer does not change the size of the volume, and there are no hyperparameters.

One or more of the layers may include a pool or pooling layer. A pooling layer performs a function to reduce the spatial dimensions of the input and control overfitting. There are different functions such as Max pooling, average pooling, or L2-norm pooling. In some embodiments, max pooling is used, which only takes the most important part (e.g., the value of the brightest pixel) of the input volume. By way of example, a pooling layer may perform a down-sampling operation along the spatial dimensions (e.g., the height and the width), which may result in a smaller volume than the input of the pooling layer (e.g., 16×16×12 from the 32×32×12 input volume). In some embodiments, the convolutional network may not include any pooling layers. Instead, strided convolution layers may be used in place of pooling layers.

One or more of the layers may include a fully connected (FC) layer. A FC layer connect every neuron in one layer to every neuron in another layer. The last FC layer normally uses an activation function (e.g., Softmax) for classifying the generated features of the input volume into various classes based on the training dataset. The resulting volume may be 1×1×number of classes.

As discussed previously, some of the layers may include parameters (e.g., weights and/or biases), such as a convolutional layer, while others may not, such as the ReLU layers and pooling layers, for example. In various embodiments, the parameters may be learned or updated during training. Further, some of the layers may include additional hyper-parameters (e.g., learning rate, stride, epochs, kernel size, number of filters, type of pooling for pooling layers, etc.), such as a convolutional layer or a pooling layer, while other layers may not, such as a ReLU layer. Various activation functions may be used, including but not limited to, ReLU, leaky ReLU, sigmoid, hyperbolic tangent (tanh), exponential linear unit (ELU), etc. The parameters, hyper-parameters, and/or activation functions are not to be limited and may differ depending on the embodiment.

Although input layers, convolutional layers, pooling layers, ReLU layers, and fully connected layers are discussed herein, this is not intended to be limiting. For example, additional or alternative layers, such as normalization layers, softmax layers, and/or other layer types, may be used in neural network 714 or neural network 752.

In various embodiments, neural network 714 or neural network 752 may be trained with labeled images using multiple iterations until the value of a loss function(s) of the machine learning model is below a threshold loss value. The loss function(s) may be used to measure error in the predictions of the machine learning model using ground truth values.

Here, using image 712 as the input, detector 710 is configured to use neural network 714 to separate the foreground from background 716, detect product 718 in the foreground, and determine area 722 of the product in the image, e.g., using various machine learning models as previously disclosed. In various embodiments, neural network 714 may output area 722 as a bounding box, usually represented by four values, such as the x and y coordinates of a corner of the bounding box as well as the height and width of the bounding box.

In various embodiments, either product 718 or area 722 may be used by selector 750 as product image 730 to compare with exemplary image 740. Neural network 752 is trained to determine respective latent neural features of input images in a latent space. In this case, latent representation 754 represents the latent neural features of product image 730, and latent representation 756 represents the latent neural features of exemplary image 740. Accordingly, latent representation 754 and latent representation 756 may be compared for their similarity measure in process 758. In some embodiments, process 758 is to computer their cosine distance in the latent space. In this way, the frame with the maximum similarity measure may be selected as the representative frame, and is to be displayed to the user.

In the context of neural networks, a latent space is the space where the neural features lie. In general, objects with similar neural features are closer together compared with objects with dissimilar neural features in the latent space. For example, when neural networks are used for image processing, images with similar neural features are trained to stay closer in a latent space. Respective latent space may be learned after each layer or selected layers. A latent space is formed in which the neural features lie. In some embodiments, the latent space contains a compressed representation of the image, which may be referred to as a latent representation. The latent representation may be understood as a compressed representation of those relevant image features in the pixel space.

In one embodiment, neural network 714 or neural network 752 can bring an image from a high-dimensional space to a bottleneck layer, e.g., where the number of neurons is the smallest. The neural network may be trained to extract the most relevant features in the bottleneck. Accordingly, the bottleneck layer usually corresponds with the lowest dimensional latent space with low-dimensional latent representations. In some embodiments, latent representation 754 and latent representation 756 are extracted from the bottleneck layer.

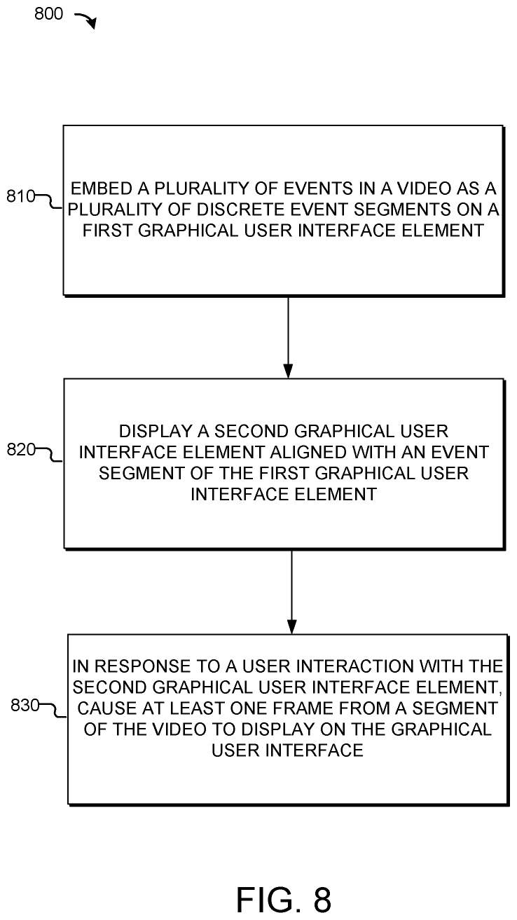

Referring now to FIG. 8, a flow diagram is provided that illustrates an exemplary process of monitoring retail transactions. Each block of process 800, and other processes described herein, comprises a computing process that may be performed using any combination of hardware, firmware, or software. For instance, various functions may be carried out by a processor executing instructions stored in memory. The process may also be embodied as computer-usable instructions stored on computer storage media or devices. The process may be provided by an application, a service, or a combination thereof.

At block 810, the process is to embed events in a video as discrete event segments on a first GUI element (e.g., element 432 in FIG. 4), e.g., via event encoder 254 or GUI manager 258 in FIG. 2. The system may encode, based on respective event types, the respective discrete event segments on the first GUI element with different colors or with different form factors. The resulting GUI features greatly enabled a user to effectively and efficiently monitor retail transactions. Further, the system is configured to map a segment of the video to the second GUI element in a one-to-one relationship.

For normal scans, the system may encode, based on respective timestamps, the normal scan events in a same color and in a same form factor as respective event segments on the first GUI element. For ticket switch events, as it also involves a scan, the system may encode them in different color, but in the same form factor as the normal scan events. For an irregular event without a machine reading of a barcode of a product between a start time and a finish time of a displacement of the product in the video, the system may encode this irregular event as a variable length segment on the first GUI element, wherein one end of the variable length segment corresponds to the start time of the displacement of the product in the video, and another end of the variable length segment corresponds to the finish time of the displacement of the product in the video.

At block 820, the process is to display a second GUI element (e.g., element 446) aligned with an event segment (e.g., element 444) of the first GUI element (e.g., element 432), e.g., via GUI manager 258 of FIG. 2. In various embodiments, the system displays the first GUI element on the GUI to represent a timeline for the events in the video. The events may be in different event types.

In various embodiments, the system is configured to display a second GUI element within a predetermined distance above, beneath, or from an event segment of the first GUI element, and may the event segment of the first GUI element to a segment of the video that comprises the corresponding event. The system is configured to display the second GUI element and the event segment together such that their respective geometric centers overlap together. The system is configured to cause the second GUI element to align with an event segment of the first GUI element, and map the second GUI element to the segment of the video associated with the event segment. The system is configured to display a third GUI element (e.g., element 448) on the graphical user interface to visually indicate a connection between the second GUI element (e.g., element 446) and the event segment (e.g., element 444) on the first GUI element.

At block 830, the process is to cause at least one frame from a segment of the video to display on the GUI in response to a user interaction with the GUI (e.g., the event segment of the first GUI element, or the second GUI element), e.g., via event manager 256 of FIG. 2. In various embodiments, the system is configured to retrieve an exemplary image of the product based on a product identifier (e.g., a barcode) associated with the event segment of the first GUI element, and cause the exemplary image of the product to display on another window of the GUI, such that one frame from the segment of the video and the exemplary image of the product are juxtaposed on the GUI.

The system is configured to, in response to the user interaction with the second GUI element, causing a third GUI element (e.g., the progress indicator) to move, based on a timestamp of the at least one frame, to a location on the first GUI element. The system is configured to select the representative frame from the segment of the video based on a similarity measure between an image of a product shown on the frame and an exemplary product image associated with the event segment of the first GUI element. The system is configured to display the second GUI element and the event segment together such that their respective geometric centers overlap together, and in response to the user interaction with the second GUI element being a double click or double tough event, cause a playback of the segment of the video including the at least on frame.

Accordingly, we have described various aspects of the technology for detecting mislabeled products. It is understood that various features, sub-combinations, and modifications of the embodiments described herein are of utility and may be employed in other embodiments without reference to other features or sub-combinations. Moreover, the order and sequences of steps shown in the above example processes are not meant to limit the scope of the present disclosure in any way, and in fact, the steps may occur in a variety of different sequences within embodiments hereof. Such variations and combinations thereof are also contemplated to be within the scope of embodiments of this disclosure.

Referring to FIG. 9, an exemplary operating environment for implementing aspects of the technology described herein is shown and designated generally as computing device 900. Computing device 900 is but one example of a suitable computing environment and is not intended to suggest any limitation as to the scope of use of the technology described herein. Neither should the computing device 900 be interpreted as having any dependency or requirement relating to any one or combination of components illustrated.

The technology described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, and specialty computing devices, etc. Aspects of the technology described herein may also be practiced in distributed computing environments where tasks are performed by remote-processing devices that are connected through a communications network.

With continued reference to FIG. 9, computing device 900 includes a bus 910 that directly or indirectly couples the following devices: memory 920, processors 930, presentation components 940, input/output (I/O) ports 950, I/O components 960, and an illustrative power supply 970. Bus 910 may include an address bus, data bus, or a combination thereof. Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. The inventors hereof recognize that such is the nature of the art and reiterate that the diagram of FIG. 9 is merely illustrative of an exemplary computing device that can be used in connection with different aspects of the technology described herein. Distinction is not made between such categories as “workstation,” “server,” “laptop,” “handheld device,” etc., as all are contemplated within the scope of FIG. 9 and refers to “computer” or “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 920 includes computer storage media in the form of volatile and/or nonvolatile memory. The memory 920 may be removable, non-removable, or a combination thereof. Exemplary memory includes solid-state memory, hard drives, optical-disc drives, etc. Computing device 900 includes processors 930 that read data from various entities such as bus 910, memory 920, or I/O components 960. Presentation component(s) 940 present data indications to a user or other device. Exemplary presentation components 940 include a display device, speaker, printing component, vibrating component, etc. I/O ports 950 allow computing device 900 to be logically coupled to other devices, including I/O components 960, some of which may be built in.

In various embodiments, monitoring logic 922 includes instruction that, when executed by processors 930, result in computing device 900 performing various functions associated with, but not limited to, event detector 252, event encoder 254, event manager 256, GUI manager 258, and MLM 260, in connection with FIG. 2; detector 710 and selector 750, in connection with FIG. 7.

In various embodiments, memory 920 includes, in particular, temporal and persistent copies of monitoring logic 922. Monitoring logic 922 includes instructions that, when executed by processor 930, result in computing device 900 performing functions, such as, but not limited to, process 800 in FIG. 8, as well as various processes connected to FIGS. 2-7.

In some embodiments, processors 930 may be packed together with monitoring logic 922. In some embodiments, processors 930 may be packaged together with monitoring logic 922 to form a System in Package (SiP). In some embodiments, processors 930 cam be integrated on the same die with monitoring logic 922. In some embodiments, processors 930 can be integrated on the same die with monitoring logic 922 to form a System on Chip (SoC).

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 930 may be direct or via a coupling utilizing a serial port, parallel port, and/or other interface and/or system bus known in the art. Furthermore, the digitizer input component may be a component separate from an output component such as a display device. In some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

Computing device 900 may include networking interface 980. The networking interface 980 includes a network interface controller (NIC) that transmits and receives data. The networking interface 980 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 980 may include a wireless terminal adapted to receive communications and media over various wireless networks. Computing device 900 may communicate with other devices via the networking interface 980 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

All patent applications, patents, and printed publications cited herein are incorporated herein by reference in the entireties, except for any definitions, subject matter disclaimers or disavowals, and except to the extent that the incorporated material is inconsistent with the express disclosure herein, in which case the language in this disclosure controls.

What is claimed is:

1. A computer-implemented method for monitoring retail transactions, the method comprising:
displaying a first graphical user interface element on a graphical user interface to represent a timeline for a plurality of events in a video, wherein the plurality of events comprise a plurality of event types;
embedding the plurality of events as a plurality of discrete event segments shown on the first graphical user interface element;
displaying a second graphical user interface element within a predetermined distance from an event segment of the first graphical user interface element, the event segment of the first graphical user interface element being mapped to a segment of the video that comprises an event of the plurality of events; and
in response to a user interaction with the second graphical user interface element, causing at least one frame from the segment of the video to display on a window of the graphical user interface.

2. The method of claim 1, further comprising:
encoding, based on respective event types, the respective discrete event segments on the first graphical user interface element with different colors.

3. The method of claim 1, wherein the plurality of event types comprise a type of normal scan, the method further comprising:
encoding, based on respective timestamps of a plurality of normal scan events, the plurality of normal scan events in a same color and in a same form factor as respective event segments on the first graphical user interface element.

4. The method of claim 1, wherein the plurality of events comprise an irregular event without a machine reading of a barcode of a product between a start time and a finish time of a displacement of the product in the video, the method further comprising:
encoding the irregular event as a variable length segment on the first graphical user interface element, wherein one end of the variable length segment corresponds to the start time of the displacement of the product in the video, and another end of the variable length segment corresponds to the finish time of the displacement of the product in the video.

5. The method of claim 1, wherein displaying the second graphical user interface element comprises displaying the second graphical user interface element within the predetermined distance above or beneath the event segment.

6. The method of claim 1, wherein displaying the second graphical user interface element comprises displaying the second graphical user interface element and the event segment together such that their respective geometric centers overlap together.

7. The method of claim 1, further comprising:
in response to a user interaction with the event segment of the first graphical user interface element, retrieving an exemplary image of a product based on a product identifier associated with the event segment of the first graphical user interface element; and
causing the exemplary image of the product to display on another window of the graphical user interface.

8. The method of claim 1, further comprising:
in response to the user interaction with the second graphical user interface element, retrieving an exemplary image of a product based on a product identifier associated with the event segment of the first graphical user interface element; and
causing the exemplary image of the product to display on another window of the graphical user interface, such that the at least one frame from the segment of the video and the exemplary image of the product are juxtaposed on the graphical user interface.

9. The method of claim 1, further comprising:
selecting the at least one frame from the segment of the video based on a similarity measure between an image of a product shown on the at least one frame and an exemplary product image associated with the event segment of the first graphical user interface element.

10. The method of claim 1, further comprising:
in response to the user interaction with the second graphical user interface element, causing a third graphical user interface element to move, based on a timestamp of the at least one frame, to a location on the first graphical user interface element.

11. A computer-readable storage device encoded with instructions that, when executed, cause one or more processors of a computing system to perform operations of monitoring retail transactions, comprising:
embedding a plurality of events in a video as a plurality of discrete event segments on a first graphical user interface element, wherein the plurality of events comprise a plurality of event types;
displaying the first graphical user interface element on a graphical user interface to represent a timeline of the plurality of events, and a second graphical user interface element to align with an event segment of the first graphical user interface element; and
in response to a user interaction with the second graphical user interface element, causing at least one frame from a segment of the video to display on a window of the graphical user interface.

12. The computer-readable storage device of claim 11, wherein the operations further comprising:
mapping the second graphical user interface element to the segment of the video; and
displaying a third graphical user interface element on the graphical user interface to represent a visual connection between the second graphical user interface element and the event segment on the first graphical user interface element.

13. The computer-readable storage device of claim 11, wherein the plurality of event types comprise a type of normal scan, wherein the operations further comprising:
encoding the plurality of discrete event segments in different colors based on their respective event types.

14. The computer-readable storage device of claim 11, wherein the plurality of events comprise an irregular event without a machine reading of a barcode of a product between a start time and a finish time of a displacement of the product in the video, wherein the operations further comprising:
encoding the irregular event as a variable length segment on the first graphical user interface element, wherein one end of the variable length segment corresponds to the start time of the displacement of the product in the video, and another end of the variable length segment corresponds to the finish time of the displacement of the product in the video.

15. The computer-readable storage device of claim 11, wherein the operations further comprising:
selecting the at least one frame from the segment of the video based on a similarity measure between an image of a product shown on the at least one frame and an exemplary product image associated with the event segment of the first graphical user interface element.

16. The computer-readable storage device of claim 11, wherein displaying the second graphical user interface element comprises displaying the second graphical user interface element and the event segment together such that their respective geometric centers overlap together, wherein the operations further comprising:
in response to the user interaction with the second graphical user interface element being a double click or double tough event, causing a playback of the segment of the video including the at least on frame, the playback starting from a beginning of the segment of the video.

17. A system for monitoring retail transactions, comprising:
a graphical user interface with a plurality of graphical user interface elements; and
a computer memory stored with instructions, wherein the instructions, when executed by a processor, cause the processor to perform operations, comprising:
embedding a plurality of events in a video as a plurality of discrete event segments on a first graphical user interface element, wherein the plurality of events comprise a plurality of event types;
displaying the first graphical user interface element on the graphical user interface to represent a timeline of the plurality of events, and a second graphical user interface element to align with an event segment of the first graphical user interface element; and
in response to a user interaction with the second graphical user interface element, causing at least one frame from a segment of the video to display on a window of the graphical user interface, the segment of the video being mapped to the second graphical user interface element in a one-to-one relationship.

18. The system of claim 17, wherein the plurality of events comprise an irregular event associated with a machine reading of a barcode of a product, wherein the operations further comprising:
retrieving an exemplary image of the product based on the barcode.

19. The system of claim 18, wherein the operations further comprising:
causing the exemplary image of the product to display on another window of the graphical user interface, such that the at least one frame from the segment of the video and the exemplary image of the product are juxtaposed on the graphical user interface.

20. The system of claim 17, wherein the operations further comprising:
encoding, based on respective event types, the respective discrete event segments on the first graphical user interface element with different form factors.
